(19) United States
(12) Patent Application Publication
(10) Pub. No.: US 2026/0196563 A1
(43) Pub. Date: Jul. 9, 2026

(54) SECONDARY BATTERY ELECTROLYTE AND ITS BATTERY

(71) Applicants: REPT BATTERO ENERGY CO., LTD., Wenzhou (CN); SHANGHAI RUIPU ENERGY CO., LTD., Shanghai (CN)

(72) Inventors: Hui CAO, Wenzhou (CN); Yi CUI, Shanghai (CN); Min HOU, Shanghai (CN); Chan LIU, Shanghai (CN)

(21) Appl. No.: 19/560,123

(22) Filed: Mar. 8, 2026

Related U.S. Application Data
(63) Continuation of application No. PCT/CN2024/124147, filed on Oct. 11, 2024.

(30) Foreign Application Priority Data
Oct. 18, 2023 (CN) 202311345453.3

(51) Int. Cl. H01M 10/0568; H01M 10/052; H01M 10/0567; H01M 10/0569

(52) U.S. Cl. CPC H01M 10/0568; H01M 10/052; H01M 10/0567; H01M 10/0569; H01M 2300/0037

(57) ABSTRACT

The present invention relates to a secondary battery electrolyte, which includes a composite electrolyte salt; the composite electrolyte salt comprises lithium hexafluorophosphate, lithium difluorosulfonate, and lithium sulfide salts; the lithium sulfide salts include substituted sulfates (R₁—SO₃—Li) and/or sulfonate structure lithium salts (R₂—O—SO₃—Li). The present invention employs a combination of LiPF₆, lithium sulfide salts, and LiFSI, where LiFSI exhibits better hydrolysis stability, superior thermal stability, and higher lithium migration capability, significantly enhancing the battery's kinetics and high-temperature performance. Lithium sulfates and sulfonate structure lithium salts also possess high lithium migration capabilities. Moreover, their anion groups rich in S and O form films that improve the composition of the SEI film and reduce membrane impedance, thereby enhancing the battery's kinetic and high-temperature performance.

### CROSS-REFERENCE TO RELATED APPLICATIONS

This application is a continuation of International Patent Application No. PCT/CN2024/124147, filed on Oct. 11, 2024, which claims the benefit of priority from Chinese Patent Application No. 202311345453.3, filed on Oct. 18, 2023. The content of the aforementioned application, including any intervening amendments thereto, is incorporated herein by reference in its entirety.

### TECHNICAL FIELD

The present invention belongs to the field of batteries, and specifically involves a secondary battery electrolyte and its battery.

### BACKGROUND TECHNOLOGY

As the extensive use of fossil fuels increasingly puts pressure on the environment, new energy technologies have received unprecedented attention and development. Secondary batteries, due to their high energy density, long service life, and no memory effect, are widely applied in the new energy sector. Customers are placing higher demands on the long-term reliability and high energy density of batteries, leading to continuous improvements and upgrades in the material design of secondary batteries.

Therefore, to meet the demand for improving the overall performance of secondary batteries, it is necessary to provide a secondary battery with excellent comprehensive performance. In batteries, the electrolyte plays a crucial role in transporting lithium ions, often referred to as the blood of the battery. The effective combination of lithium salts in the electrolyte can significantly enhance the battery's kinetic capabilities and improve its high-temperature performance.

### SUMMARY OF THE INVENTION

The purpose of the present invention is to provide a secondary battery electrolyte and its battery for solving the problems existing in the prior art. The purpose of the present invention can be achieved by the following scheme:

The present invention provides a secondary battery electrolyte, which includes a composite electrolyte salt. The composite electrolyte salt comprises lithium hexafluorophosphate (LiPF₆), lithium difluorosulfonyl imide (LiFSI), and a lithium salt of a chalcogenide; the lithium salt of the chalcogenide comprises substituted sulfates (R₁—SO₃—Li) and/or sulfonate structure lithium salts (R₂—O—SO₃—Li).

The structure of the sulfate (R₁—SO₃—Li) is shown in formula 1, and R₁ includes one of alkyl, haloalkyl, hydroxyl, carboxyl, aldehyde, hydroxyethyl, carbonyl, aryl, benzyl, pyrazolyl and imidazolyl.

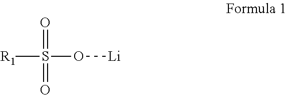

The structure of sulfonate lithium salt (R₂—O—SO₃—Li) is shown in formula 2, and R₂ includes one of alkyl, unsaturated ethyl to hexyl, halogenated alkyl, hydroxyl, carboxyl, aldehyde, hydroxyethyl, carbonyl, aryl, benzyl, pyrazolyl, imidazole, etc.

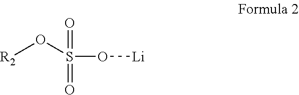

As one embodiment of the present invention, the alkyl in the sulfate (R₁—SO₃—Li) structure is substituted with methyl, ethyl, propyl, butyl, pentyl, hexyl, heptyl, octyl, nonyl or decyl.

As one embodiment of the present invention, the halogenated alkyl group in the structure formula of sulfate (R₁—SO₃—Li) is replaced by a fluorinated alkyl group.

As one embodiment of the present invention, in the structure formula of sulfonate structure lithium salt (R₂—O—SO₃—Li), the alkyl group includes methyl, ethyl, propyl, butyl, pentyl, hexyl, heptyl, octyl, nonyl or decyl.

As one embodiment of the present invention, in the composite electrolyte salt, the mass ratio of lithium hexafluorophosphate (LiPF₆), lithium difluorosulfonyl imide (LiFSI) and lithium sulfide salt is 1:(0.05~150):(0.005~10), preferably 1:(0.1~10):(0.07~3).

As one embodiment of the present invention, the lithium sulfide salt is preferably a combination of substituted sulfate and sulfonate structure lithium salts; in the lithium sulfide salt, the mass ratio of the substituted sulfate and sulfonate structure lithium salts is 1:(0.1~10), preferably 1:(0.15~5).

As one embodiment of the present invention, the molar ratio of S to P in the lithium sulfide salt is 0<S/P<=10.

As one embodiment of the present invention, the molar ratio of S to P in the composite electrolyte salt is 0<S/P≤10, preferably 1.4<S/P<6. The molar ratio of S to P represents the proportion of sulfur-containing lithium salts in the lithium salt related to LiPF₆, influencing the percentage of sulfate, sulfite, or organic components with sulfate groups in the SEI after film formation; sulfur-containing components in the SEI film enhance the stability of the SEI film, thereby improving the thermal stability, cycling stability, and overall performance of the battery.

As one embodiment of the present invention, the secondary battery electrolyte further includes an organic solvent, which comprises cyclic carbonate solvents and non-equivalent length chained carbonate solvents. The cyclic carbonate solvents include one or more of ethylene carbonate (EC), propylene carbonate (PC), and difluorinated ethylene carbonate (DFEC). The non-equivalent length chained carbonate solvents include one or more of methyl ethyl carbonate (EMC), n1-fluoromethyl ethyl carbonate, and n₂-chloromethyl ethyl carbonate. Here, n₁ is the number of fluorine atoms substituted in the fluoromethyl ethyl carbonate, and n₂ is the number of chlorine atoms substituted in the chloromethyl ethyl carbonate.

As one embodiment of the present invention, the organic solvent also includes long-chain carbonate solvents. The long-chain carbonate solvents include dimethyl carbonate (DMC), diethyl carbonate (DEC), n₃-fluorodimethyl carbonate, n₄-fluorodipropyl carbonate, n₅-chlorodimethyl carbonate, and no-chlorodipropyl carbonate, either individually or in combination. Here, n₃ represents the number of fluorine atoms substituted in the fluorodimethyl carbonate, n₄ represents the number of fluorine atoms substituted in the difluorodipropyl carbonate, n₅ represents the number of chlorine atoms substituted in the chlorodimethyl carbonate, and n₆ represents the number of chlorine atoms substituted in the chlorodipropyl carbonate.

As one embodiment of the present invention, the secondary battery electrolyte further comprises additives, which include key additives; the key additives include one or more of vinylene carbonate (VC), vinyl sulfate (DTD) and methanesulfonic acid dimethyl ester (MMDS).

As one embodiment of the present invention, the additive further includes auxiliary additives, which include lithium difluorophosphate (LDFP), lithium di-fluoroborate (LiODFB), lithium di-fluoroborate phosphate (LiODFP), lithium di-borate (LiBOB), lithium perchlorate (LiClO₄), lithium fluosulfate (LiSO₃F), lithium nitrate (LiNO₃), lithium tetrafluoroborate phosphate (LiOTFP), tri-(tri-methylsilyl) phosphate ester (TMSP), tri-(tri-methylsilyl) borate ester (TMSB), 1,3-propanesulfonic acid lactone (PS), propenyl sulfonic acid lactone (PST), propenyl sulfite (TMS), vinylene carbonate (FEC), and tetraethylenecyclohexane (TS), either individually or in combination.

As one embodiment of the present invention, the content of the components in the electrolyte of the secondary battery is calculated according to the following formula:

$$0.25 \leq F = \frac{8 1.5 - {W}_{cyclic} \% \times 100 - {W}_{non - equivalentchain} \% \times 100}{( {W}_{lithiumsalt} \% \times 100 ) \times ( {W}_{key additives} \% \times 100 )} \leq 1.55$$

Among them, F value is the key characteristic ratio of the electrolyte, W_{cyclic}% represents the mass percentage of cyclic carbonate solvent in the electrolyte, W_{non-equivalent chain}% represents the mass percentage of non-equivalent length chained carbonate solvents in the electrolyte, W_{lithium salt}% represents the mass percentage of composite electrolyte salts in the electrolyte, and W_{key additives}% represents the mass percentage of key additives in the electrolyte.

The present invention also provides a battery, including the secondary battery electrolyte.

Compared with the existing technology, the present invention has the following beneficial effects:

(1) The combination of LiPF₆, lithium sulfide salts, and LiFSI, where LiPF₆ serves as the traditional lithium salt with moderate stability and lower cost, but falls short in meeting current battery performance requirements. LiFSI exhibits superior hydrolytic stability, better thermal stability, and higher lithium migration capability, significantly reducing battery impedance and enhancing room-temperature cycling kinetics. Batteries with dense films and low impedance often have better room-temperature cycling performance. In the present invention, lithium sulfide salts include substituted sulfates and/or sulfonates, which also possess high lithium migration capabilities. Moreover, their anion clusters rich in S and O contribute to improving the composition of solid electrolyte interface (SEI) films and reducing film impedance. Additionally, the composite components of sulfates, sulfites, and organic SEI films containing sulfate groups exhibit good thermal stability, increasing the thermal decomposition temperature of SEI films and enhancing battery safety. Therefore, the combined use of LiPF₆, lithium sulfide salts, and LiFSI significantly improves battery kinetics and high-temperature stability, thereby enhancing battery safety;

(2) Batteries using electrolytes with F value range have better high temperature storage performance; for electrolyte design, rapid and effective initial determination can be made.

### DETAILED DESCRIPTION

The following is a detailed description of the present invention with reference to specific embodiments. The examples provided below are implemented under the technical solution of the present invention, offering detailed implementation methods and specific operational processes that will help those skilled in the field to further understand the present invention. It should be noted that the scope of protection of the present invention is not limited to the embodiments described below; any adjustments and improvements made under the premise of the concept of the present invention also fall within the scope of protection of the present invention.

The polyvinylidene fluoride in the embodiments and comparative examples of the present invention is PVDF_5130.

The grade of polyvinylpyrrolidone in the embodiments and comparative examples of the present invention is PVP_30.

The sodium carboxymethyl cellulose used in the embodiments and comparative examples of the present invention is CMC_500.

### Example 1

In this embodiment, the battery electrochemical system used is lithium iron phosphate battery. In the electrolyte of this embodiment, the electrolyte includes:

The composite electrolyte salt consists of LiPF₆+LiFSI+lithium tributanesulfonate (LiC₄F₉SO₃)+lithium ethanesulfonate (LiCH₃SO₄), where the LiPF₆ content is 6 wt. %, the LiFSI content is 5 wt. %, the LiC₄F₉SO₃ content is 1 wt. %, and the LiCH₃ SO₄ content is 1 wt. %. The mass percentage of the composite electrolyte salt in the electrolyte is 13 wt. % (W_{lithium salt}%), and the molar ratio of S to P in the composite electrolyte salt is S/P=1.65;

The cyclic carbonate solvent includes EC 13 wt. %+PC13 wt. %, and the mass percentage of the cyclic carbonate solvent in the electrolyte 26 wt. % (W_{cyclic}%);

The EMC of the long chain solvent is 12 wt. % (W_{long chain}%);

The key additive is 3.5 wt. % (W_{key additive}%), in which the key additive includes VC (ethyl vinyl carbonate) and DTD with a mass ratio of 3:0.5;

The auxiliary additive is 1.3 wt. %, in which the auxiliary additive includes LiODFB and FEC with a mass ratio of 0.5:0.8;

Isocarbonated solvent of equal length: the remainder (44.2 wt. %), where the isocarbonated solvent of equal length includes DMC and DEC in a mass ratio of 1:1.

The components and contents of the electrolyte in embodiment 1 are shown in Table 1, and the F value of embodiment 1 is 0.956.

The process of preparing the battery in this embodiment is as follows:

First, the slurry is mixed. The ratio of cathode slurry is lithium iron phosphate: conductive carbon black (Super P): binder (polyvinylidene fluoride PVDF_5130): dispersant (polyvinylpyrrolidone PVP_30)=100:2:2.5:0.5.

The ratio of anode slurry is graphite: conductive agent (Super P): binder (styrene-butadiene rubber (SBR)): binder (sodium carboxymethyl cellulose CMC_500): H₂O=100:2:2:0.8:99.

Then, the coating process is carried out, with the cathode slurry applied to the aluminum foil and the anode slurry applied to the copper foil, followed by drying and rolling. Next, roll pressing is performed, followed by cutting. After that, the cell core is wound using the prepared positive and anodes and separator, which uses a PP separator (12 μm base film+2 μm Al₂O₃ ceramic layer+1 μm PVDF adhesive layer). The wound cell core is then hot-pressed and the top cover is welded, after which it is assembled into the case to form the dry cell.

After the dry cell is baked, the electrolyte is injected. After the battery is immersed, the formation and capacity sorting are carried out to obtain the finished cell.

### Example 2

This embodiment provides a secondary battery electrolyte, the composition selection and its content are shown in Table 1. The difference from Example 1 is that: the lithium sulfide salt only includes 2 wt. % LiC₄F₉SO₃, does not include LiCH₃SO₄, and the molar ratio of S to P in the composite electrolyte salt is S/P=1.52.

### Example 3

This embodiment provides a secondary battery electrolyte, the composition selection and its content are shown in Table 1. The difference from Example 1 is that: the lithium sulfide salt only includes 2 wt. % LiC₄F₉SO₃, does not include LiC₄F₉SO₃, and the molar ratio of S to P in the composite electrolyte salt is S/P=1.78.

### Example 4

The difference between this embodiment and Example 1 is as follows: lithium trifluoromethanesulfonate (LiCF₃SO₃) replaces the sulfate, and lithium benzenesulfonate (LiC₆H₅SO₄) replaces the sulfonate structure lithium salt. The LiPF₆ content is 8 wt. %, the LiFSI content is 8 wt. %, the LiCF₃SO₃ content is 8 wt. %, and the LiC₆H₅SO₄ content is 2 wt. %. The mass percentage of the composite electrolyte salt in the electrolyte is 26 wt. % (W_{lithium salt}%), and the content of the long-chain carbonate solvent is 31.2 wt. %. The F value obtained in this embodiment is 0.478, and the molar ratio of S to P in the composite electrolyte salt is S/P=2.81.

### Example 5

The difference between this embodiment and Example 1 is as follows: instead of sulfates, lithium benzyl sulfate (Li(C₆H₅)CH₂SO₃), sulfonate structure lithium salt is used, specifically lithium sulfoxide (LiC₃H₃N2SO₄), with LiPF₆ content being 3 wt. %, LiFSI 5 wt. %, Li(C₆H₅)CH₂SO₃ 0.5 wt. %, LiC₃H₃N₂SO 0.5 wt. %, respectively. The mass percentage of the composite electrolyte salt in the electrolyte is 9 wt. % (W lithium salt %), and the content of the long-chain carbonate solvent is 48.2 wt. %. The F value obtained from this embodiment is 1.381, and the molar ratio of S to P in the composite electrolyte salt is S/P=3.00.

### Example 6

This comparative example provides a secondary battery electrolyte, with component selection and their contents as shown in Table 1. The difference from Example 1 is that the LiPF₆ content is 2 wt. %, the LiFSi content is 3 wt. %, the LiC₄F₉SO₃ content is 1 wt. %, and the LiCH₃SO₄ content is 1 wt. %. The mass percentage of composite electrolyte salt in the electrolyte is 7 wt. % (W_{lithium salt}%), and the content of isomeric chain carbonate solvent is 50.2 wt. %. The F value obtained from this embodiment is 1.776, and the molar ratio of S to P in the composite electrolyte salt is S/P=3.33.

### Comparative Example 1

This comparative example provides a secondary battery electrolyte, the composition content is shown in Table 1, and the difference from Example 1 is that the lithium sulfide salt is replaced with an equal amount of lithium hexafluorophosphate, and the molar ratio of S to P in the composite electrolyte salt is S/P=1.02.

### Comparative Example 2

This comparative example provides a secondary battery electrolyte, the composition content of which is shown in Table 1, and the difference from Example 1 is that the lithium sulfide salt is replaced with an equal amount of difluorosulfonyl imide lithium, and the molar ratio of S and P in the composite electrolyte salt is S/P=1.89.

### Comparative Example 3

This comparative example provides a secondary battery electrolyte, the composition content is shown in Table 1, and the difference from Example 1 is that the lithium sulfide salt is replaced with an equal amount of lithium tetrafluoroborate (LiBF₄), and the molar ratio of S to P in the composite electrolyte salt is S/P=1.35.

TABLE 1

| | | Mass percentage of each component (wt. %) | | | | | | | | |
|---|---|---|---|---|---|---|---|---|---|---|
| | | based on total mass of electrolyte | | | | | | | | |
| | | | | | | | | Comparative | | |
| | | Examples | | | | | | Examples | | |
| | | 1 | 2 | 3 | 4 | 5 | 6 | 1 | 2 | 3 |
| Lithium | | 6 | 6 | 6 | 8 | 3 | 2 | 8 | 6 | 6 |
| hexafluorophosphate | | | | | | | | | | |
| (LiPF₆) | | | | | | | | | | |
| Lithium | | 5 | 5 | 5 | 8 | 5 | 3 | 5 | 7 | 5 |
| difluorosulfonyl | | | | | | | | | | |
| imide (LiFSI) | | | | | | | | | | |
| Sulfide | Replace | 1 | 2 | | 8 | 0.5 | 1 | | | |
| lithium | sulfate | | | | | | | | | |
| salts | Sulfate | 1 | | 2 | 2 | 0.5 | 1 | | | |
| | structure | | | | | | | | | |
| | lithium | | | | | | | | | |
| | salt | | | | | | | | | |
| Cyclic | EC | 13 | 13 | 13 | 13 | 13 | 13 | 13 | 13 | 13 |
| carbonate | PC | 13 | 13 | 13 | 13 | 13 | 13 | 13 | 13 | 13 |
| solvent | | | | | | | | | | |
| Non- | EMC | 12 | 12 | 12 | 12 | 12 | 12 | 12 | 12 | 12 |
| equivalent | | | | | | | | | | |
| long chain | | | | | | | | | | |
| carbonate | | | | | | | | | | |
| solvent | | | | | | | | | | |
| Isopentyl | DMC + | remainder | remainder | remainder | remainder | remainder | remainder | remainder | remainder | remainder |
| carbonate | DEC | | | | | | | | | |
| solvent | | | | | | | | | | |
| Lithium | 0 | 0 | 0 | 0 | 0 | 0 | 0 | 0 | 0 | 2 |
| tetrafluoroborate | | | | | | | | | | |
| Key | VC + | 3.5 | 3.5 | 3.5 | 3.5 | 3.5 | 3.5 | 3.5 | 3.5 | 3.5 |
| additive | DTD | | | | | | | | | |
| Auxiliary | LiODFB + | 1.3 | 1.3 | 1.3 | 1.3 | 1.3 | 1.3 | 1.3 | 1.3 | 1.3 |
| additive | FEC | | | | | | | | | |

| | | | | | | | | | |
|---|---|---|---|---|---|---|---|---|---|
| F value | 0.956 | 0.956 | 0.956 | 0.478 | 1.381 | 1.776 | 0.956 | 0.956 | 0.956 |

The electrolyte of each embodiment and the comparative electrolyte were assembled into a pouch battery according to the steps of embodiment 1, and the performance was tested. The normal temperature cycle test steps are as follows:
1. 0.5C CC charging to 4.25V;
2. Set aside for 10 min;
3. 1C discharge to 2.8V;
4. Set aside for 10 min;
5. Repeat the above steps;
6. Check the capacity retention rate at 500 cycles.

The high temperature storage step test is as follows:
7. Charge the battery to 4.25V at 0.05C CCCV, cutoff at 0.5C;
8. Store the battery in a 60° C. oven for 14 days;
9. Place the battery in room temperature environment for cooling for 4 h;

The battery is discharged to 2.8V at 1C, and the remaining capacity is recorded as the test data of each embodiment and the comparative example as shown in Table 2.

TABLE 2

| | 500 cycle capacity | Remaining |
|---|---|---|
| | retention rate (%) | capacity (%) |
| Example 1 | 96.12 | 86.9 |
| Example 2 | 93.06 | 84.4 |
| Example 3 | 91.71 | 82.8 |
| Example 4 | 96.03 | 86.2 |
| Example 5 | 94.77 | 84.9 |
| Example 6 | 87.52 | 78.6 |
| Comparative | 82.65 | 72.5 |
| Example 1 | | |
| Comparative | 86.19. | 74.2 |
| Example 2 | | |
| Comparative | 80.44 | 71.3 |
| Example 3 | | |

From the comparative examples 1-3, it can be seen that when no lithium sulfide salt salt is added to the electrolyte, the capacity retention rate and high temperature storage performance at 500 cycles are decreased.

The above describes specific embodiments of the present invention. It should be understood that the present invention is not limited to the specific embodiments described above, and those skilled in the art can make various modifications or variations within the scope of the claims, which do not affect the essential content of the present invention.

What is claimed is:

1. A secondary battery electrolyte, characterized in that the secondary battery electrolyte comprises a composite electrolyte salt; the composite electrolyte salt comprises lithium hexafluorophosphate, lithium difluorosulfonyl imide and a lithium sulfide salt; the lithium sulfide salt comprises substituted sulfate or sulfonate structure lithium salts; 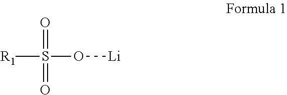
The structure of the compound that replaces sulfate is shown in formula 1, and R₁ includes one of alkyl, haloalkyl, hydroxyl, carboxyl, aldehyde, hydroxyethyl, carbonyl, aryl, benzyl, pyrazolyl, and imidazolyl; 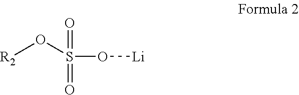
The structure of the sulfonate structure lithium salt is shown in formula 2; R₂ includes one of alkyl, unsaturated ethyl to hexyl, halogenated alkyl, hydroxyl, carboxyl, aldehyde, hydroxyethyl, carbonyl, aryl, benzyl, pyrazolyl, imidazole and so on.

2. The electrolyte for a secondary battery according to claim 1, characterized in that the lithium sulfide salt is a combination of substituted sulfate and sulfate structure lithium salts.

3. The electrolyte for secondary battery according to claim 1, characterized in that the molar ratio of S element and P element in the composite electrolyte salt is 0<S/P<=10.

4. The electrolyte for a secondary battery according to claim 1, characterized in that the electrolyte for a secondary battery further comprises an organic solvent, the organic solvent comprising a cyclic carbonate solvent and a non-equivalent length chained carbonate solvent.

5. The electrolyte for a secondary battery according to claim 4, characterized in that the cyclic carbonate solvent comprises one or more of ethylene carbonate, propylene carbonate, and difluoromethyl carbonate; the non-equivalent length chained carbonate solvent comprises one or more of methyl ethyl carbonate, n1-fluoromethyl ethyl carbonate, and n₂-chloromethyl ethyl carbonate.

6. The electrolyte for a secondary battery according to claim 4, characterized in that the organic solvent further comprises an equal length chain carbonate solvent; the equal length chain carbonate solvent includes dimethyl carbonate, diethyl carbonate, n₃-fluorodimethyl carbonate, n4-fluorodisethyl carbonate, n₅-chlorodimethyl carbonate, or n₆-chlorodisethyl carbonate, either individually or in combination.

7. The electrolyte for a secondary battery according to claim 4, characterized in that the electrolyte for a secondary battery further comprises additives, said additives comprising key additives; said key additives comprising one or more of vinylene carbonate, ethyl sulfate and methanesulfonic acid dimethyl ester.

8. The electrolyte for a secondary battery according to claim 7, characterized in that the additive further comprises auxiliary additives, which include lithium difluorophosphate, lithium borate difluorocholate, lithium difluoroborate dihydrogen phosphate, lithium borate dihydrogen phosphate, lithium perchlorate, lithium fluosulfate, lithium nitrate, lithium tetrafluoroborate dihydrogen phosphate, tri (tert-methylsilyl) phosphate ester, tri (tert-methylsilane) borate ester, 1,3-propanesulfonic acid lactone, acrylate lactone, propenyl sulfite, vinylene carbonate, and tetraethylenesilane, either individually or in combination.

9. The electrolyte for a secondary battery according to claim 7, characterized in that the content of the components in the electrolyte for a secondary battery is calculated according to the following formula:
$$0.25 \leq F = \frac{8 1.5 - {W}_{cyclic} \% \times 100 - {W}_{non - equivalentchain} \% \times 100}{( {W}_{lithiumsalt} \% \times 100 ) \times ( {W}_{key additives} \% \times 100 )} \leq 1.55$$
Among them, F value is the key characteristic ratio of the electrolyte, W_{cyclic}% represents the mass percentage of cyclic carbonate solvent in the electrolyte, W_{non-equivalent chain}% represents the mass percentage of non-equivalent length chained carbonate solvents in the electrolyte, W_{lithium salt}% represents the mass percentage of composite electrolyte salt in the electrolyte, and W_{key additive}% represents the mass percentage of key additives in the electrolyte.

10. A battery, characterized in that the battery comprises a secondary battery electrolyte as claimed in claim 1.
